(19) United States
(12) Patent Application Publication
(10) Pub. No.: US 2009/0163386 A1
(43) Pub. Date: Jun. 25, 2009

(54) COMPOSITIONS FOR DRILLING FLUIDS USEFUL TO PRODUCE FLAT TEMPERATURE RHEOLOGY TO SUCH FLUIDS OVER A WIDE TEMPERATURE RANGE AND DRILLING FLUIDS CONTAINING SUCH COMPOSITIONS

(75) Inventor: David DINO, Cranbury, NJ (US)

Correspondence Address: MORGAN, LEWIS & BOCKIUS LLP, 1701 MARKET STREET, PHILADELPHIA, PA, 19103-2921, US

(73) Assignee: Elementis Specialties, Inc., Highstown, NJ (US)

(21) Appl. No.: 12/395,024

(22) Filed: Feb. 27, 2009

Related U.S. Application Data
(63) Continuation-in-part of application No. 11/963,182, filed on Dec. 21, 2007.
Application No. 11/963,182 is a continuation of application No. 10/304,167, filed on Nov. 27, 2002, now Pat. No. 7,345,010.
Application No. 10/304,167 is a continuation-in-part of application No. 12/075,027, filed on Mar. 7, 2008.

(51) Int. Cl. C09K 8/02

(52) U.S. Cl. 507/103

(57) ABSTRACT

A drilling fluid additive characterized by a drilling fluid viscosity regulating property which imparts a stable rheological profile to an oil based drilling fluid characterized by a substantially constant equivalent circulating density over a temperature range of about 120° F. to about 40° F. or a substantially constant high shear rate viscosity reading measured at 600 rpm. The present invention further provides an oil based drilling fluid including a continuous base oil phase; a weighting agent; a filtrate reducer; an emulsifier; and an effective amount of a rheological additive. The oil based drilling fluid exhibits a substantially constant equivalent circulating density and a substantially constant high shear rate viscosity reading over a temperature range of about 120° F. to about 40° F.

### RELATED APPLICATIONS

This application is a continuation-in-part of U.S. patent application Ser. No. 11/963,182, filed Dec. 21, 2007, which is a continuation of U.S. patent application Ser. No. 10/304,167, now U.S. Pat. No. 7,345,010, filed Nov. 27, 2002. Furthermore, this application is continuation-in-part of U.S. patent application Ser. No. 12/075,027, filed Mar. 7, 2008.

### FIELD OF THE INVENTION

This invention relates to compositions suitable for use as additives for drilling fluids, and to drilling fluids comprising such compositions having improved rheological properties. The invention also relates to additives that provide rheological properties to drilling fluids relatively independent of the varying temperatures encountered in oil well drilling operations at various depths, particularly in deep water drilling.

### BACKGROUND OF THE INVENTION

Drilling fluids have been used since the very beginning of oil well drilling operations in the United States and drilling fluids and their chemistry have been and remain an important area for scientific and chemical investigations. The use and desired properties of drilling fluids are comprehensively reviewed in recent U.S. Pat. Nos. 6,339,048 and 6,462,096, issued to the assignee of this application, the entire disclosures of which are incorporated herein by reference.

A drilling fluid is typically a thixotropic system and exhibits low viscosity when sheared at the bit during cutting of the hole into the ground, during agitation and circulation but, when such shearing action is halted, must quickly thicken to among other things carry the “cuttings” from the bottom of the drilled hole to surface while minimizing the cuttings from slipping back down the hole. The fluid must therefore become thick rapidly, reaching sufficient gel strength before such suspended materials fall any significant distance. Importantly, this behavior must be totally reversible at all temperatures encountered in the borehole. In addition, even when the drilling fluid is free flowing, it must retain a sufficiently high viscosity to carry all cuttings and other particulate matter from the bottom of the hole back up to the surface as well as suspend uniformly any weight material, such as barite, that is incorporated into the drilling fluid.

Since the end of the second World War, hydrocarbon drilling for exploratory and production wells has increasingly been done from platforms located in water settings, often called off-shore drilling. Such fresh and salt water drilling employs floating barges and rigs often fixed in some fashion to the submerged surface of the earth.

Economic and technical advances have recently pushed these drilling operations into deeper waters. Although advances in equipment and engineering have yielded technology capable of drilling in water depths up to 10,000 feet or more, advances required in drilling fluid technology have lagged.

A major problem with oil-based drilling fluids in deepwater drilling is rheological additive temperature sensitivity over the temperature range encountered. During circulation, the drilling fluid typically reaches bottom hole temperatures of about 140° F. to 175° F. followed by cooling to lower than 40° F. in the riser during its travel upward (due to the inherent low temperature of sea water far below the ocean surface). For successful deepwater drilling, the mud needs to simultaneously suspend the solids and remain pumpable with proper viscosity over these wide temperature ranges.

Drilling fluids thickened with conventional organophilic clay rheological additives particularly suffer considerable viscosity build as the drilling fluid is cooled from a temperature of 140° F. to 40° F., for example. As a result of this viscosity increase, the drilling fluid, when it reaches low temperatures, is more difficult to pump, the equivalent circulating density (ECD) is increased and losses to the formation (lost circulation) frequently increase. This increase in ECD can result in opening fractures in the formation, and serious losses of the wellbore fluid into the fractured formation.

The requirements for drilling fluids with enhanced temperature properties have also become more complex over the past two decades as a result of changes in directional drilling technology, in which a well is drilled at an angle other than vertical. Such wells are widely known as deviated wells.

Methods for drilling deviating wells have changed greatly over recent years with the production of more powerful and reliable downhole motors, and the invention of more accurate methods utilizing wireline techniques as well as the highly computerized downhole, sensing and micro reduction equipment, including improvements in sounding apparatus and microwave transmission. These techniques permit the instantaneous acquisition of data relating to down-hole conditions without the need to remove the drill string and in fact mean that holes can, and are, drilled at ever increasing lengths.

The advantages of directional drilling include (1) directional drilling allows tapping of fields which cannot effectively be reached by vertical drilling; (2) such drilling permits the use of more economical land-based equipment to explore the immediate off-shore environment; and (3) such drilling make possible the drilling of multiple wells up to several miles from one another, sharing the cost of a single site. In addition, in certain geological formations, increased production can be achieved by deviating the well off-vertical so as to facilitate perforation and development of a narrow producing zone, or redevelopment of a depleted formation.

Use of a downhole motor allows the hole to be deviated by the introduction of a fixed offset or bend just above the drill bit. This offset or bend can be oriented by modern MWD systems which are capable of reporting accurately the current bit and toolface hole angle and azimuth (i.e. the orientation with respect to the upper portion of the hole). It is accordingly possible to rotate the drill string until the toolface has achieved the desired direction of deviation, and then to fix the drill string in place and commence the deviation by starting the motor to extend the hole in the desired deviated direction.

There are, however, a number of inherent problems in the use of directional drilling, which affect the requirements of a drilling mud; namely: As in deep water drilling, increased ranges of temperatures are encountered. The annulus carrying the mud to the surface is no longer vertical and extends to far greater distances versus vertical wells. Gravity on a horizontal hole pulls cuttings, weighting material and particulate matter, not controlled by the drilling fluid, to the bottom side of the bore (not the bottom of the hole as in traditional drilling) and results in drag on the bore wall. The amount of drilling mud required is increased since the distances are greater, and the time required for the mud to reach the earth's surface also increases. Curves and kinks in the hole's direction can accumulate cuttings and additives.

In order to obviate or mitigate these problems, which can cost oil and gas companies millions of dollars per hole, it is an object of the invention to provide drilling fluids with rheological properties particularly appropriate for directional drilling including the improved viscosity stability with temperature discussed above.

For background, it has been long known that organoclays (also called organophilic clays) can be used to thicken drilling fluids. See the very early article by the employee of the assignee hereof J. W. Jordan, “Proceedings of the 10th National Conference on Clays and Clay Minerals” (1963), which discusses a wide range of drilling applications of organoclays from high polarity liquids to low polarity liquids.

Previously mentioned U.S. Pat. No. 6,462,096 discloses oil-based invert emulsion drilling fluids that provide more stable drilling fluid viscosity and anti-settling performance over varying temperatures when compared to conventional fluids containing organoclays.

Patents of the prior art that show developments related to either drilling fluids or chemistry of additives include the following:

U.S. Pat. No. 3,514,399 teaches the use of a mixed dimer acid-monocarboxylic acid salt of an imidazoline in a drilling fluid.

U.S. Pat. No. 5,260,268 describes a product introduced into a well borehole which encompasses water-based drilling fluids and shows a composition comprised of a polycarboxylic acrylating agent reacted with an amine-terminated polyethylene of a molecular weight average from 600 to 10,000. While ethoxylated amines are discussed as a surfactant which may be used in conjunction with the composition, there is no teaching of applications in an oil-based invert emulsion drilling fluid.

U.S. Patent Application Publication No. 2001/0009890 shows an invert emulsion suitable for drilling a subterranean well which uses an ester of a C₁ to C₁₂ alcohol and a C₈ to C₂₄ monocarboxylic acid—Ethomeen C/₁₅ can be used as an agent in the invention described in the application.

U.S. Pat. No. 5,536,871 issued to the assignee hereof describes a rheological additive which comprises the reaction product of a polyalkoxylated nitrogen-containing compound such as polyoxyethylene (5) cocoalkylamine, a polycarboxylic acid including dimer acids and a liquid diamine.

U.S. Pat. No. 5,610,110 also issued to assignee hereof shows an improved drilling fluid containing a reaction product of an alkoxylated aliphatic amino compound and an organic polycarboxylic acid and a clay based organoclay.

U.S. Pat. No. 5,909,779 at Col. 4, lines 55 to Col. 5, line 15 contains a large laundry list of surfactants, wetting agents and viscosifying agents conventionally used in oil-based drilling fluids including fatty acids, polyamines, imidazoline derivatives and polycarboxylic acids and soaps of fatty acids.

Recent Dow Chemical Company U.S. Pat. No. 6,291,406 describes a well treatment fluid using an amine surfactant to provide a sufficiently stable emulsion. Ethomeens are discussed, particularly bis(2-hydroxyethyl) cocamines and oleyamines.

Commercial rheological drilling fluid additives presently available on the market, however, tend to have increased viscosity while the fluid temperature is low, requiring increased pump pressure which in turn causes increased wear of the drilling gear. Increased pumping horsepower becomes necessary to pump drilling muds through long distances, and increased down-hole pressure under pumping conditions increases fluid loss, fracturing and damage of the formation. Prior art methods of reducing drilling fluid viscosity are not satisfactory because the resultant drilling fluids fail to maintain adequate suspension characteristics when the fluid temperature changes, for example, at down-hole conditions.

There is clearly an unfilled need which has been growing in the past decade for drilling fluids that are able to maintain a relatively consistent rheological profile over a wide temperature range; it is believed that the below unexpected described invention fills this need.

### SUMMARY OF THE INVENTION

The present invention provides for a drilling fluid additive characterized by a drilling fluid viscosity regulating property which imparts a stable rheological profile to an oil based drilling fluid. In one embodiment, the stable rheological profile is characterized by a substantially constant equivalent circulating density over a temperature range of about 120° F. to about 40° F. In another embodiment, the stable rheological profile is characterized by a substantially constant high shear rate viscosity reading over a temperature range of about 120° F. to about 40° F., where the high shear rate viscosity reading is measured at 600 rpm.

The present invention further provides an oil based drilling fluid comprising: a continuous base oil phase; an emulsified internal phase (typically brine), a weighting agent; a filtrate reducer; an emulsifier; and an effective amount of a rheological additive. In one embodiment, the oil based drilling fluid exhibits a substantially constant high shear rate viscosity reading over a temperature range of about 120° F. to about 40° F., where the high shear rate viscosity reading is measured at 600 rpm. In another embodiment, the rheological additive has a drilling fluid viscosity regulating property which imparts a stable rheological profile to the oil based drilling fluid. In one such embodiment, the stable rheological profile is characterized by a substantially constant equivalent circulating density over a temperature range of about 120° F. to about 40° F.

The present invention still further provides for a method of drilling in a subterranean formation. The method comprises the steps of: providing an oil based drilling fluid and drilling into the subterranean formation with the oil based drilling fluid. The oil based drilling fluid comprises: a continuous base oil phase; an emulsified internal phase (typically brine), a weighting agent; a filtrate reducer, an emulsifier; and an effective amount of a rheological additive. In one embodiment, the oil based drilling fluid exhibits a substantially constant high shear rate viscosity reading over a temperature range of about 120° F. to about 40° F., where the high shear rate viscosity reading is measured at 600 rpm. In another embodiment, the theological additive has a drilling fluid viscosity regulating property which imparts a stable rheological profile to an oil based drilling fluid. In one embodiment, the stable rheological profile corresponds to a substantially constant equivalent circulating density over a temperature range of about 120° F. to about 40° F.

In one embodiment, the stable rheological profile is further characterized by an increase in high shear rate viscosity reading for the oil based drilling fluid of up to 70% over a temperature range of about 120° F. to about 40° F. The high shear rate viscosity reading may be measured at 600 rpm. In another embodiment, the stable rheological profile is further characterized by the oil based drilling fluid having a low shear rate viscosity reading of at least 6 viscosity units over a temperature range of about 120° F. to about 40° F. The low shear rate viscosity reading may be measured at 6 rpm. In yet another embodiment, the drilling fluid additive is substantially free of organophilic clay. In still another embodiment, the drilling fluid additive contains an organophilic clay.

In accordance with another aspect, the present invention provides for an oil based drilling fluid comprising: a continuous oil phase; an emulsified internal phase (typically brine), a weighting agent; a filtrate reducer; an emulsifier; and an effective amount of a rheological additive. The oil based drilling fluid exhibits a substantially constant equivalent circulating density over a temperature range of about 120° F. to about 40° F.

In accordance with yet another aspect, the present invention further yet provides for a method of drilling in a subterranean formation. The method comprises the steps of: providing an oil based drilling fluid and drilling into the subterranean formation with the oil based drilling fluid. The oil based drilling fluid comprises: a continuous base oil phase; an emulsified internal phase (typically brine), a weighting agent; a filtrate reducer; an emulsifier; and an effective amount of a rheological additive. The oil based drilling fluid exhibits a substantially constant equivalent circulating density over a temperature range of about 120° F. to about 40° F.

In one embodiment, the oil based drilling fluid further exhibits an increase in high shear rate viscosity reading of up to 70% when operating at a temperature range of about 120° F. to about 40° F. In another embodiment, the oil based drilling fluid further exhibits a low shear rate viscosity reading of at least 6 viscosity units over a temperature range of about 120° F. to about 40° F.

### DETAILED DESCRIPTION OF EMBODIMENTS

The present invention provides for: a drilling fluid additive and a method of drilling a subterranean formation using the additive. The drilling fluid additive may be characterized by a drilling fluid viscosity regulating property which imparts a stable rheological profile to an oil based drilling fluid. In one embodiment, drilling fluids containing the drilling fluid additive of the present invention exhibit a substantially constant equivalent circulating density and stable high shear rate viscosity reading over a wide temperature range, e.g., 40° F. to 120° F. In another embodiment, drilling fluid additives containing the drilling fluid additive of the present invention exhibit a substantially constant high shear rate viscosity reading over a temperature range of about 120° F. to about 40° F., where the high shear rate viscosity reading is measured at 600 rpm. Additionally, the high shear rate viscosity reading of the drilling fluid of the invention is relatively low at reduced temperatures, e.g., 40° F., while still providing sufficient low shear rate viscosity under downhole temperatures, e.g., 120° F., to reduce barite sag and to suspend drill cuttings.

The additive may be used in a variety of applications such as oil based drilling fluids, invert emulsion drilling fluids and drill-in fluids. It also may be used in deep-water drilling, horizontal drilling, slim hole drilling and the more conventional vertical drilling. This invention particularly covers non aqueous based or synthetic or oil-based drilling fluids, e.g., invert emulsion based drilling fluids. The term oil-based drilling fluid is defined as a drilling fluid in which the continuous phase is hydrocarbon based. In one embodiment, it relates to an oil based drilling fluid often referred to as an invert emulsion drilling fluid, which is a water in oil emulsion whose continuous phase is oil. Oil-based fluids formulated with over 5% water or brine are classified as oil-based invert emulsion drilling fluids. The water or brine phase, such as calcium chloride, can range from 0% in all oil muds to in excess of 50% in invert emulsion drilling fluids.

The term “drilling fluid” conventionally denotes any of a number of liquid and gaseous fluids and mixtures of fluids and solids (as solid suspensions, mixtures and emulsions of liquids, gases and solids) used in operations to drill boreholes into the earth. It is synonymous with “drilling mud” in general usage.

In one embodiment, the invention provides for a drilling fluid additive composition characterized by a drilling fluid viscosity regulating property which imparts a stable rheological profile to an oil based drilling fluid. In one such embodiment, the stable rheological profile may correspond to a substantially constant equivalent circulating density (“ECD”) as temperature is varied over a range of about 120° F. to about 40° F. In another embodiment, the stable rheological profile may further correspond to the degree of change in high shear rate viscosity for the oil based drilling fluid over a temperature range of about 120° F. to about 40° F. In yet another embodiment, the stable rheological profile further corresponds to the oil based drilling fluid having a low shear rate viscosity reading sufficient to lift cuttings from the hole over such temperature range.

In another embodiment, the invention provides for an oil based drilling fluid including: a continuous oil phase; a weighting agent; a filtrate reducer; an emulsifier; and an effective amount of a rheological additive. In one such embodiment, the oil based drilling fluid exhibits a substantially constant ECD as temperature is varied over a range of about 120° F. to about 40° F. In another embodiment, the oil based drilling fluid exhibits a minimal degree of change, an increase or decrease, in high shear rate viscosity for the oil based drilling fluid over a temperature range of about 120° F. to about 40° F. In yet another embodiment, the oil based drilling fluid has a low shear rate viscosity reading sufficient to lift cuttings from the hole over such temperature range.

An effective amount of a rheological additive may include: 0.05 wt. % of rheological additive, 0.1 wt. % of rheological additive; 0.2 wt. % of rheological additive; 0.3 wt. % of rheological additive; 0.4 wt. % of rheological additive; 0.5 wt. % of rheological additive; 0.6 wt. % of rheological additive; 0.7 wt % of rheological additive; 0.8 wt. % of rheological additive; 0.9 wt. % of rheological additive; 1.0 wt. % of rheological additive; 1.5 wt. % of rheological additive; 2.0 wt. % of rheological additive; 3.0 wt. % of rheological additive; 4.0 wt. % of rheological additive; 5.0 wt. % of rheological additive; and up to 10 wt. % of rheological additive. In one such embodiment, the rheological additive may be characterized by a viscosity regulating property.

The drilling fluid additive and drilling fluid may be characterized by several rheological or hydraulic aspects, i.e., ECD, high shear rate viscosity, low shear rate viscosity, plastic viscosity, regulating property viscosity and yield point, of a drilling fluid. The rheological aspects may be determined using a Fann viscometer as per standard procedures found in API RP13B-2 “Standard Procedures for Field Testing Oil-based Drilling Fluids”. Viscosity readings can be measured at 600 rpm, 300 rpm, 200 rpm, 100 rpm, 6 rpm and 3 rpm. ECD can be determined by: standard hydraulics calculations found in API RP13D “Rheology and Hydraulics of Oil-well Drilling Fluids.” For the purposes of this invention high shear rate viscosity (“HSR”) corresponds to the viscosity measured at 600 rpm as per API RP13B-2 procedures. For the purposes of this invention, low shear rate viscosity (“LSR”) corresponds to the viscosity measured at 6 rpm as per API RP 13B-2 procedures. Plastic viscosity (“PV”) corresponds to the 600 rpm reading minus the 300 rpm reading. Yield Point (“YP”) corresponds to the 300 rpm reading minus plastic viscosity.

In one embodiment, an oil based drilling fluid may exhibit and/or a stable rheological profile may correspond to the oil based drilling fluid having a substantially constant ECD as temperature is varied over a range of about 120° F. to about 40° F. For the purposes of this invention, a substantially constant ECD may include a decrease or increase in ECD over such temperature variation. In one embodiment, the increase in ECD may include: up to 0.5%; up to 1%; up to 2%, up to 3%, up to 4%; up to 5%; up to 10%; up to 20%; up to 30%; and up to 40%. In one embodiment, the decrease in ECD may include: up to 0.5%; up to 1%; up to 2%, up to 3%, up to 4%; up to 5%; up to 10%; up to 20%; up to 30%; and up to 40%.

In another embodiment, the oil based drilling fluid may further exhibit and/or the stable rheological profile may further correspond to a change in high shear rate viscosity for the oil based drilling fluid. For the purposes of this invention, a change in high shear rate viscosity reading may include an increase or decrease in high shear rate viscosity reading over such temperature range. In one such embodiment, the increase in high shear rate viscosity reading may include: up to 10%; up to 20%; up to 25%; up to 30%; up to 35%; up to 40%; up to 45%; up to 50%; up to 55%; up to 60%; up to 65%; up to 70%; up to 75%; up to 80%; up to 85%; up to 90%; up to 95%; up to 100% and up to 120%. In another such embodiment, the decrease in high shear rate viscosity reading may include: at least 10%; at least 20%; at least 25%; at least 30%; at least 35%; at least 40%; at least 45%; at least 50%; at least 55%; at least 60%; at least 65%; at least 70%; at least 75%; at least 80%; at least 85%; at least 90%; at least 95%; up to 100% and up to 120%.

In yet embodiment, the oil based drilling fluid may further exhibit and/or the stable rheological profile may further correspond to the oil based drilling fluid having a LSRV sufficient to lift cuttings from the hole over such a temperature range. In one such embodiment, the LSR reading may correspond to: at least 3 viscosity units, at least 6 viscosity units; at least 8 viscosity units; at least 10 viscosity units; and at least 12 viscosity units. In another such embodiment, the LSR reading may correspond to a range of: about 4 to about 10 viscosity units; and about 5 to about 15 viscosity units.

In still yet another embodiment, the oil based drilling fluid may further exhibit and/or the stable rheological profile may further correspond to a condensed viscosity range profile over a shear range of about 600 rpm to about 6 rpm. In such embodiments at mud weights of 12 pounds/gallon, the condensed viscosity profile may correspond to: up to 80 viscosity units; up to 100 viscosity units; up to 120 viscosity units; up to 140 viscosity units; up to 180 viscosity units; up to 2000 viscosity units; up to 240 viscosity units; up to 280 viscosity units; up to 320 viscosity units; and up to 360 viscosity units.

Drilling Fluid Additive

Suitable drilling fluid additives may include natural organic polymers and/or surfactants; or synthetic organic polymers and/or surfactants. In one such embodiment, the drilling fluid additive may contain an organoclay. In another such embodiment, the drilling fluid additive may be substantially free of organoclay. For purposes of this invention, substantially free of organoclay corresponds to less than 0.001 ppb organoclay.

In one embodiment, the drilling fluid additive may include a polyamide. In one such embodiment, the polyamide drilling fluid additive may include a reaction product of a carboxylic acid with at least two carboxylic moieties, and a polyamine having an amine functionality of two or more. In another embodiment, the polyamide drilling fluid additive consists essentially of a reaction product of a carboxylic acid with at least two carboxylic moieties, and a polyamine having an amine functionality of two or more.

Any carboxylic acid with at least two carboxylic moieties can be used for producing the reaction product component of the polyamide drilling fluid additive. In some embodiments, the carboxylic acid is a dimer acid. In some embodiments, the carboxylic acid includes dimer acids of C₁₆ and/or C₁₈ fatty acid. In certain embodiments, such dimer acids are fully hydrogenated, partially hydrogenated, or not hydrogenated at all. In some embodiments, dimer acids include products resulting from the dimerization of C₁₆ to C₁₈ unsaturated fatty acids.

In some embodiments, the dimer acids have an average of about 18 to about 48 carbon atoms. In some embodiments, the dimer acids have an average of about 20 to 40 carbon atoms. In one embodiment, the dimer acids have an average of about 36 carbon atoms.

Suitable dimer acids may be prepared from C₁₈ fatty acids, such as oleic acids. Examples of suitable dimer acids are described in U.S. Pat. Nos. 2,482,760, 2,482,761, 2,731,481, 2,793,219, 2,964,545, 2,978,468, 3,157,681, and 3,256,304, the entire disclosures of which are incorporated herein by reference.

Examples of suitable dimer acids include the Empol® product line available from Cognis Inc. (eg: Empol® 1061), and Pripol® dimer acids available from Uniqema (eg: Pripol® 1013).

In some embodiments, the carboxylic acid includes a trimer acid. In some embodiments, trimer acids are included in the drilling fluid additive though the addition of commercial dimer acid products such as Empol® 1061 or Pripol® 1013. In some embodiments, the carboxylic acid does not include a trimer acid.

Many commercially available dimer fatty acids contain a mixture of monomer, dimer, and trimer acids. In some embodiments, the dimer fatty acid has a specific dimer content as increased monomer and trimer concentration may hinder the additive's performance. In some embodiments, commercial products are distilled or otherwise processed to ensure certain suitable dimer content. In some embodiments, a suitable dimer acid has a dimer content of at least about 80%. In some embodiments, suitable dimer acid has a dimer content of at least about 90%. An example of a suitable dimer acid includes Empol® 1061, which has a dimer acid content of 92.5%-95.5%, a trimer acid content of 1.5%-3.5% and a monoacid content of 2.5% -5.0%.

According to some embodiments, polyamines having an amine functionality of two or more are used for the preparation of a reaction product that may be incorporated in the drilling fluid additive. In some embodiments, polyamines from the family of polyethylene polyamines having an amine functionality of two or more are used.

Di-, tri-, and polyamines and their combinations may be suitable for use in the drilling fluid additive. Examples of such amines may include ethylenediamine, diethylenetriamine, triethylenetetramine, tetraethylenepentamine and other members of this series. In some embodiments, branched polyamines and polyamines made with different alkyl groups are used.

In some embodiments, a suitable triamine is diethylenetramine (DETA). DETA has been assigned a CAS No. of 111-40-0 and is commercially available from Huntsman International.

Specifics on processing of polyamines and carboxylic acids are well known and can be used in making the reaction product for incorporation in the drilling fluid additive. in some embodiments, the molar ratio between the amine functional group and carboxyl functional group is about 4:1 to about 1:1. In some embodiments, the molar ratio between the amine functional group and carboxyl functional group is about 1.5:1 to about 3:1. In some embodiments, the molar ratio between the amine functional group and carboxyl functional group is about 2:1. For example, mixtures or reactions of more than one dimer acid and/or more than one polyamine can be used. In some embodiments, these reactions may generate imidazolines and other side products.

In some embodiments, the polyamide reaction product has an average molecular weight of about 1,000 to about 5,000 g/mole. In some embodiments the reaction product has an average molecular weight of about 1,990 to about 2,040 g/mole.

Optional Ingredients in the Drilling Fluid Additive

Optionally, additional ingredients may be added to the polyamide drilling fluid additive or may be added directly to the drilling mud itself. Such optional ingredients may include fatty acid amides and/or alkoxylated alkyl amines.

In some embodiments, suitable fatty amides are amides of fatty acids that are sparingly soluble in drilling fluids. In some embodiments, suitable fatty amides include high temperature melting amides of fatty acids that are sparingly soluble in drilling muds, such as the Armid® product line by Akzo Nobel. In some embodiments, alkoxylated fatty amides, such as the Ethomid® product line by Akzo Nobel can be used. For example, a suitable alkoxylated fatty amide may include Ethomid® O/17 which has 7 moles of EO on oleamide. In some embodiments, a fatty acid amide is added directly to the drilling mud.

In another embodiment, an alkoxylated alkyl amine is mixed into or blended into the reaction product produced by the reaction of the carboxylic acid with the polyamine as described above or is otherwise added directly to the drilling mud.

Many alkyl alkoxylated amines are suitable for the present invention. Any alkoxylated amine or similarly derivitized amines may be used. Suitable alkoxylated amines include amines of various degrees of alkoxylation. Representative useful chemicals include the entire Ethomeen®, Propomeen® and the Ethoduomeen® product lines of Akzo Nobel.

Preferred are amines with up to about 50 units of alkoxylation per molecule (e.g. Ethomeen® 18/60). More preferred are amines with up to about 15-25 units of alkoxylation (e.g. Ethomeen® C/25, T/25, S/25, 18/25; Ethoduomeen® T/25). Most preferred are amines with up to about 2-10 units of alkoxylation (e.g. Propomeen® C/12, O/12, T/12; Ethoduomeen® T/13, T/20; Ethomeen® C/12, C/15, C/20, O/12, O/15, T/12, T/15, S/12, S/15, S/20, 18/12, 18/15 and 18/20).

The most preferred amines are polyoxyethylene (5) cocoalkylamines, available, for example, under the tradename Ethomeen® C/15 from Akzo Nobel (New Brunswick, N.J.). Ethomeen® C/15 has a general formula of RN[(CH₂CH₂O)ₘ[CH₂CH₂O)ₙH] wherein R is cocoalkyl, and m+n=5.

In one embodiment, the alkoxylated amine may be added prior to the reaction between the dimer acid and polyamines, or blended after the reaction step. If added prior to the reaction or at the reaction temperature, some esters may be formed between the dimer acid carboxyls and the alkoxylated amine hydroxyls. In one embodiment, the polyamide reaction product and the alkoxylated amine may be mixed or blended in a weight ratio range of: 95:5 to 5:95: 80:20 to 30:70. In another embodiment, weight ratio is 55:45 polyamide reaction product to alkoxylated amine.

While the above is the preferred formulation, other compositions of varying molar ratios of raw materials can be used. Additionally, alternate commercial dimer fatty acids can be reacted with various amines to generate the reaction polymer. It however should also be noted that the alkoxylated amine could be reacted with the dimer acid/diethylenetriamine polymer generating compositions which can be further modified by blending amine derivatives (e.g. fatty amides) and this is intended to be included in this invention.

Preparation of and Components of Drilling Fluids

A process for preparing invert emulsion drilling fluids (oil muds) involves using a mixing device to incorporate the individual components making up that fluid. Primary and secondary emulsifiers and wetting agents (surfactant mix) are added to the base oil (continuous phase) under moderate agitation. The water phase, typically a brine, is added to the base oil/surfactant mix along with alkalinity control agents and acid gas scavengers. Rheological additives as well as fluid loss control materials, weighting agents and corrosion inhibition chemicals may also be included, and the agitation is continued to ensure dispersion of each ingredient and homogenize the resulting fluidized mixture.

Suitable Oil Base

Typical continuous phase products include but are not limiteded to diesel oil, mineral oil, synthetic oil, vegetable oil, fish oil, paraffinics, and/or ester-based oils. These can all be used as single components or as blends.

Suitable Brine Content

Water in the form of brine is often used in forming the internal phase of these type fluids. Water can be defined as an aqueous solution which can contain from about 10 to 350,000 parts-per-million of metal salts such as lithium, sodium, potassium, magnesium, cesium, or calcium salts. The preferred brines used to form the internal phase of the preferred fluid of the invention can also contain from about 5 to about 35% by weight calcium chloride and may contain various amounts of other dissolved salts such as sodium bicarbonate, sodium sulfate, sodium acetate, sodium borate, potassium chloride, sodium chloride or formates (sodium, calcium, or cesium).

The ratio of water (brine) to oil in the emulsions of the invention should generally provide as high a brine content as possible while still maintaining a stable emulsion. Oil/brine ratios in the range from about 97:3 to about 50:50 have been found to work satisfactorily, depending upon the particular oil and mud weight. Thus the water content of a typical drilling fluid prepared according to the teachings of the invention will have an aqueous (water) content of about 0 to 50 volume percent.

Suitable Emulsifiers

In order to form a more stable emulsion, an emulsifier can also be added to the external, the internal or both phases of the drilling fluid. The emulsifier is preferably selected from a number of organic acids which are familiar to those skilled in the drilling fluid area, including the monocarboxyl alkanoic, alkenoic, or alkynoic fatty acids containing from 3 to 20 carbon atoms, and mixtures thereof. Examples of this group of acids include stearic, oleic, caproic, capric and butyric acids. Adipic acid, a member of the aliphatic dicarboxylic acids can also be used. More preferred surfactants or emulsifiers include fatty acid calcium salts and lecithin. Most preferred surfactants or emulsifiers include oxidized tall oil, polyaminated fatty acids, and partial amides of fatty acids.

An important class of heterocyclic additives which we believe assist in regulating the flow properties of the drilling muds according to the invention are the imidazoline compounds. Other important members of this heterocylic group are alkylpyridines.

Industrially obtainable amine compounds for use as emulsifiers are often derived from the epoxidation of olefinically unsaturated hydrocarbon compounds with subsequent introduction of the N function by addition to the epoxide group. The reaction of the epoxidized intermediate components with primary or secondary amines to form the corresponding alkanolamines is of significance in this regard. Polyamines, particularly lower polyamines of the corresponding alkylenediamine type, are also suitable for opening of the epoxide ring.

Another class of the oleophilic amine compounds useful as emulsifiers are aminoamides derived from preferably long-chain carboxylic acids and polyfunctional, particularly lower, amines of the above-mentioned type. The key factor in their case is that at least one of the amino functions is not bound in amide form, but remains intact as a potentially salt-forming basic amino group. The basic amino groups, where they are formed as secondary or tertiary amino groups, may contain hydroxyalkyl substituents and, in particular, lower hydroxyalkyl substituents containing up to 5 and preferably up to 3 C atoms in addition to the oleophilic part of the molecule.

Suitable N-basic starting components for the preparation of such adducts containing long-chain oleophilic molecule constituents are monoethanolamine or diethanolamine.

Weighting Agents

Weighting materials are also often used to weight the well bore fluids of the invention to a density in the preferred range from about 8 to 18 pounds per gallon and greater. Weighting materials well known in the art include barite, ilmenite, calcium carbonate, iron oxide and lead sulfide. The preferred weighting material is commercially available barite.

Rheologicals

In one emboidment, the drilling fluid additive and/or drilling fluid may contain rheological additive such as an organoclay. Organoclays made from bentonite, hectorite and attapulgite clays can be added to the inventive drilling fluids. There are a large number of suppliers of such clays in addition to Elementis Specialties' BENTONE® product line including Rockwood Specialties, Inc. and Sud Chemie GmbH. Alternative chemistries for generating viscosity, such as EPDM and their deriviatives can also be used. One EPDM derivative was provided by Exxon Chemicals under the name Tekmud 1949. Although a rheological additive such as an organoclay or EPDM derivative can be a useful component, it is not a necessary component of the drilling fluid. Some of the chemistries used to control fluid loss, such as styrene butadiene and their derivatives can also be used as a rheological additive.

Blending Process

Drilling fluids preparations preferably contain between ¼ and 15 pounds of the inventive mixture per barrel of fluids, more preferred concentration is ¼ to 10 pounds-per-barrel and most preferably ¼ to 5 pounds-per-barrel.

As shown above, a skilled artisan will readily recognize that additional additives: weighting agents, emulsifiers, wetting agents, viscosifiers, fluid loss control agents, and other agents can be used with this invention. A number of other additives besides rheological additives regulating viscosity and anti-settling properties, providing other properties, can also be used in the fluid so as to obtain desired application properties, such as, for example, anti-settling agents and fluid loss-prevention additives.

The drilling fluids of the present invention generally have a lower high shear rate viscosity at 40° F. than conventional muds formulated with sufficient organoclay to provide suspension at bottom hole temperatures. When used in drilling operations, the present drilling fluids allow the use of a lower pumping power to pump drilling muds through long distances, thereby reducing down-hole pressures. Consequently, fluid loss, fracturing and damage of the formation are all minimized. Drilling fluids of the present invention also advantageously maintain the suspension characteristics typical of higher levels of organoclays at higher temperatures. The present invention is particularly useful in deep water drilling when the mud is cooled in the riser. A mud using the described invention will maintain a reduced viscosity increase in the riser when compared to drilling fluids containing conventional rheological additives. One advantage is a stable rheological profile which corresponds to a substantially constant equivalent circulating density over a temperature range of about 120° F. to about 40° F.

### EXAMPLES

### Example 1

### Inventive Polyamide Drilling Fluid Additive

Examples of the inventive polyamide drilling fluid additive are described in Examples 1 and 3 of U.S. Pat. No. 7,345,010 B2 entitled “Compositions For Drilling Fluids Useful To Provide Flat Temperature Rheology To such Fluids Over A Wide Temperature Range And Drilling Fluids Containing Such Compositions” which is incorporated by reference in its entirety herein.

### Examples 2-4

A drilling fluid was prepared based on the formulation in Table 1 for use in Examples 2-4 as follows.

TABLE 1
Drilling Fluid Formulation
12.0 PPG; 85:15 Oil:Water

| Fluid Formulation | Lbs./BBL |
|---|---|
| Synthetic Based Oil (C16-C18 blend) | 171.7 |
| Emulsifier | 10 |
| 30% Calcium Chloride Brine | 73.5 |
| Lime | 4 |
| Rheological Additive | See Tables for |
| | Concentrations |
| Barite | 241 |

All fluids were prepared and tested according to standard API RP 13B mud preparation guidelines using standard malt cups and a 5 spindle Hamilton Beach multimixer. After initial make up of all the drilling fluid (mud) and characterization was completed (120° F.), the drilling fluid (mud) was subjected to a dynamic thermal treatment of 150° F. for 16 hours.

### Example 2

### Drilling Fluid Containing the Inventive Drilling Fluid Additive of Example 1

The drilling fluid additive of Example 1 was added in various amounts to the drilling fluid formulation of Table 1. ECD and viscosity readings at various shear rates and temperatures measured at 40° F. and 120° F. are listed in Tables 2. At 0.5 ppb additive concentration, the ECD changed by 2.1% over a temperature range of 40° F. to 120° F. By increasing the amount of additive, the change in ECD was reduced to as little as 0.1% at 2 ppb additive. Also, the high shear rate viscosity reading changed by 50% at 0.5 ppb additive to as low as 46% for 2 ppb additive.

TABLE 2
Example 2 Drilling Fluid Additive Concentration Evaluation

| | Additive Concentration | | | | | | | | |
|---|---|---|---|---|---|---|---|---|---|
| | 0.5 ppb | 0.5 ppb | 0.5 ppb | 1.0 ppb | 1.0 ppb | 1.0 ppb | 2.0 ppb | 2.0 ppb | 2.0 ppb |
| OFI 800 Viscosity @ | 120° F. | 40° F. | Percent | 120° F. | 40° F. | Percent | 120° F. | 40° F. | Percent |
| 120° F. | Test | Test | Change | Test | Test | Change | Test | Test | Change |
| 600 RPM Reading | 60 | 90 | 50 | 64 | 113 | 76 | 78 | 114 | 46 |
| 300 RPM Reading | 35 | 52 | 48 | 41 | 69 | 68 | 53 | 70 | 32 |
| 200 RPM Reading | 26 | 38 | 46 | 31 | 50 | 62 | 44 | 54 | 22 |
| 100 RPM Reading | 16 | 23 | 43 | 22 | 30 | 36 | 33 | 37 | 12 |
| 6 RPM Reading | 6 | 8 | 33 | 13 | 11 | 15 | 24 | 16 | 33 |
| 3 RPM Reading | 8 | 7 | 12 | 12 | 10 | 16 | 21 | 15 | 28 |
| Apparent Visc., cPs | 30 | 45 | 50 | 32 | 56 | 75 | 39 | 57 | 46 |
| Plastic Visc., cPs | 25 | 38 | 52 | 23 | 44 | 48 | 25 | 44 | 76 |
| Yield Point, Lbs/100 ft\hat{ }2 | 10 | 14 | 40 | 18 | 25 | 38 | 28 | 26 | 7 |
| Electrical Stability | 357 | — | — | 407 | — | — | 395 | — | — |
| 10 sec gel | 9 | — | — | 19 | — | — | 27 | — | — |
| 10 min gel | 13 | — | — | 22 | — | — | 31 | — | — |
| ECD, lbs/gal | 12.15 | 12.35 | 2.1 | 12.35 | 12.52 | 1.3 | 12.51 | 12.53 | 0.1 |

Example 2 Drilling Fluid Additive of Example 1 Concentration Evaluation

| | Additive Concentration | | | | | |
|---|---|---|---|---|---|---|
| | | | 3 ppb | | | 3 bbp |
| | 3.0 ppb | 3.0 ppb | Percent | 4.0 ppb | 4.0 ppb | Percent |
| OFI 800 Viscosity | 120° F. Test | 40° F. Test | Change | 120° F. Test | 40° F. Test | Change |
| 600 RPM Reading | 73 | 103 | 41 | 40 | 84 | 110 |
| 300 RPM Reading | 42 | 60 | 43 | 21 | 48 | 128 |
| 200 RPM Reading | 31 | 43 | 38 | 13 | 33 | 154 |
| 100 RPM Reading | 19 | 25 | 31 | 6 | 19 | 216 |
| 6 RPM Reading | 13 | 5 | 61 | 1 | 3 | 200 |
| 3 RPM Reading | 12 | 4 | 66 | 1 | 2 | 100 |
| Apparent Visc. cPs | 37 | 52 | 35 | 20 | 42 | 110 |
| Plastic Visc., cPs | 31 | 43 | 38 | 19 | 36 | 89 |
| Yield Point, Lbs/100 ft\hat{ }2 | 11 | 17 | 54 | 2 | 12 | |
| Electrical Stability | 652 | — | — | 609 | — | — |
| 10 sec gel | 16 | — | — | 2 | — | — |
| 10 min gel | 21 | — | — | 2 | — | — |
| ECD, lbs/gal | 12.29 | 12.41 | 1.0 | 12.22 | 12.32 | 0.8 |

### Example 3

The drilling fluid additive of Example 1 in combination with BENTONE 155® was added in various amounts to the drilling fluid formulation of Table 1. ECD and viscosity readings at various shear rates and temperatures measured at 40° F. and 120° F. are listed in Table 3.

TABLE 3
Example - Drilling Fluid Additive of Example 1 in Combination with Bentone ® 155.

| | Additive | | | | | | | | |
|---|---|---|---|---|---|---|---|---|---|
| | Bentone ® | | | | | | | | |
| | 155/ | Bentone ®155/ | | Bentone ® | Bentone ® 155/ | | Bentone ® | Bentone ® | |
| | Example 1 | Example 1 | | 155/Example | Example 1 | | 155/Example | 155/Example | |
| | Additive | Additive | | 1 Additive | Additive | | 1 Additive | 1 Additive | |
| | Additive(s) concentation | | | | | | | | |
| OFI 800 | 1.0 ppb/1.0 ppb | 1.0 ppb/1.0 ppb | Percent | 1.5 ppb/1.5 ppb | 1.5 ppb/1.5 ppb | Percent | 2.0 ppb/2.0 ppb | 2.0 ppb/2.0 ppb | Percent |
| Viscosity | 120° F. Test | 40° F. Test | Change | 120° F. Test | 40° F. Test | Change | 120° F. Test | 40° F. Test | Change |
| 600 RPM | 68 | 145 | 113 | 76 | 166 | 118 | 90 | 202 | 124 |
| Reading | | | | | | | | | |
| 300 RPM | 42 | 86 | 104 | 49 | 102 | 108 | 60 | 121 | 100 |
| Reading | | | | | | | | | |
| 200 RPM | 32 | 62 | 93 | 38 | 76 | 100 | 48 | 98 | 104 |
| Reading | | | | | | | | | |
| 100 RPM | 21 | 38 | 81 | 26 | 48 | 85 | 36 | 63 | 75 |
| Reading | | | | | | | | | |
| 6 RPM | 9 | 13 | 44 | 14 | 18 | 28 | 21 | 27 | 28 |
| Reading | | | | | | | | | |
| 3 RPM | 8 | 11 | — | 13 | 17 | — | 20 | 25 | — |
| Reading | | | | | | | | | |
| Apparent | 34 | 73 | — | 38 | 83 | — | 45 | 101 | — |
| Visc., cPs | | | | | | | | | |
| Plastic Visc., | 26 | 59 | — | 27 | 64 | — | 30 | 81 | — |
| cPs | | | | | | | | | |
| Yield Point, | 16 | 27 | — | 22 | 38 | — | 30 | 40 | — |
| Lbs/100 Ft\hat{ }2 | | | | | | | | | |
| Electrical | 267 | | | 284 | | | 301 | | |
| Stability | | | | | | | | | |
| 10 Sec Gel | 11 | | | 17 | | | 23 | | |
| 10 Min Gel | 18 | | | 25 | | | 30 | | |
| ECD, Lbs/Gal | 12.21 | 12.36 | 1.2 | 12.27 | 12.47 | 1.6 | 12.36 | 12.51 | 1.2 |

### Example 4

### Prior Art Organoclay

BENTONE 155®, an organoclay, was added to the drilling fluid of Table 1 in an amount of 6.0 ppb. Test data for the viscosity measurements at various shear rates and temperatures of the drilling fluid with the organoclay are included in Table 4. This concentration of Bentone 155® results in a similar 6 RPM reading as compared to 1.5 PPB of BENTONE 155® and 1.5 PPB additive of Example 1 as shown in Table 3. In contrast to the results drilling fluid additive of Example 1, in Tables 2 and 3, when the temperature was reduced from 120° F. to 40° F., the oil-based drilling fluid incorporating 6 ppb organoclay (BENTONE 155®) alone as a rheological modifier exhibited the following changes: a change in ECD of 10.5% a high shear rate (600 rpm) viscosity reading increase of 211.0% (78 to 243); and a low shear rate (6 rpm) viscosity reading increase of 200.0% (13 to 39). At 40° F., the viscosity profile from 600 RPM to 6 RPM was 204 viscosity units.

TABLE 4

| | BENTONE 155 ® | | |
|---|---|---|---|
| | Additive Concentration | | |
| | 6.0 ppb | 6.0 ppb | Percent |
| OFI 800 Viscosity @ 120° F. | 120° F. Test | 40° F. Test | Change |
| 600 RPM Reading | 78 | 243 | 211 |
| 300 RPM Reading | 53 | 174 | 228 |
| 200 RPM Reading | 44 | 142 | 227 |
| 100 RPM Reading | 31 | 100 | 222 |
| 6 RPM Reading | 13 | 39 | 200 |
| 3 RPM Reading | 12 | 38 | 217 |
| Apparent Visc., cPs | 39 | 121.5 | 211 |
| Plastic Visc., cPs | 25 | 69 | 176 |
| Yield Point, Lbs/100 ft\hat{ }2 | 28 | 105 | 275 |
| Electrical Stability | 527 | 548 | 3.8 |
| ECD lbs/gal | 12.51 | 13.82 | 10.5 |

### Examples 5-7

Drilling fluids were prepared based on the formulation in Table 5 for use in Examples 5-7 and 10.

TABLE 5
Drilling Fluid Formulation
12.0 PPG; 85:15 Oil:Water

| Fluid Formulation | Lbs./BBL |
|---|---|
| Synthetic Based Oil | 186 |
| Primary Emulsifier | 4 |
| Secondary Emulsifier | 2 |
| 30% Calcium Chloride Brine | 75 |
| Lime | 4 |
| Rheological Additive | See Tables for |
| | Concentrations |
| Barite | 215 |

### Example 5

### Drilling Fluid Containing the Inventive Drilling Fluid Additive of Example 1 in Combination with an Organoclay

2.5 ppb BENTONE 155® was combined with the drilling fluid additive of Example 1, the reaction product of a dimer acid and diethylene triamine (DETA), in the drilling fluid of Table 5. The viscosity measurements at various shear rates and temperatures of the drilling fluid with the organoclay and drilling fluid additive are included in Table 6. Table 6 shows that an oil-based drilling fluid incorporating 2.5 ppb organoclay (BENTONE 155®) and 0.5 ppb of the drilling fluid additive of Example 1 exhibited a high shear rate (600 rpm) viscosity reading increase of 55.7% (61 to 95) when the temperature was reduced from 120° F. to 40° F., and a low shear rate (6 rpm) viscosity reading increase of 62.5% (8 to 13) when the temperature was reduced from 120° F. to 40° F.

An oil-based drilling fluid incorporating 2.5 ppb organoclay and 0.75 ppb of the drilling fluid additive of Example 1 exhibited a high shear rate viscosity reading increase of 52.2% (67 to 102) when the temperature was reduced from 120° F. to 40° F. and a low shear rate viscosity reading increase of 40.0% (10 to 14) when the temperature was reduced from 120° F. to 40° F.

An oil-based drilling fluid incorporating 2.5 ppb organoclay and 1.0 ppb of the drilling fluid additive of Example 1 exhibited a high shear rate viscosity reading increase of 47.9% (73 to 108) when the temperature was reduced from 120° F. to 40° F. and a low shear rate viscosity reading increase of 25.0% (12 to 15) when the temperature was reduced from 120° F. to 40° F.

TABLE 6
BENTONE ® 155 with Dimer Acid/Example 1 Product Concentration Evaluation

| | Additive | | | | | | | | |
|---|---|---|---|---|---|---|---|---|---|
| | BENTONE ® 155 with Dimer | | | BENTONE ® 155 with Dimer | | | BENTONE ® 155 with Dimer | | |
| | Acid/DETA Product | | | Acid/DETA Product | | | Acid/DETA Product | | |
| | Additive(s) Concentration | | | | | | | | |
| | 2.5 ppb/ | 2.5 ppb/ | 2.5 ppb/ | 2.5 ppb/ | 2.5 ppb/ | 2.5 ppb/ | 2.5 ppb/ | 2.5 ppb/ | 2.5 ppb/ |
| | 0.5 ppb | 0.5 ppb | 0.5 ppb | 0.75 ppb | 0.75 ppb | 0.75 ppb | 1.0 ppb | 1.0 ppb | 1.0 ppb |
| OFI 800 | 120° F. | 40° F. | Percent | 120° F. | 40° F. | Percent | 120° F. | 40° F. | Percent |
| Viscosity | Test | Test | change | Test | Test | change | Test | Test | change |
| 600 RPM | 61 | 95 | 55.7% | 67 | 102 | 52.2% | 73 | 108 | 47.9% |
| Reading | | | | | | | | | |
| 300 RPM | 38 | 59 | 55.3% | 42 | 65 | 54.8% | 45 | 67 | 48.9% |
| Reading | | | | | | | | | |
| 200 RPM | 29 | 46 | 58.6% | 32 | 53 | 65.6% | 36 | 53 | 47.2% |
| Reading | | | | | | | | | |
| 100 RPM | 19 | 30 | 57.9% | 21 | 33 | 57.1% | 24 | 34 | 41.7% |
| Reading | | | | | | | | | |
| 6 RPM | 8 | 13 | 62.5% | 10 | 14 | 40.0% | 12 | 15 | 25.0% |
| Reading | | | | | | | | | |
| 3 RPM | 7 | 12 | 71.4% | 9 | 13 | 44.4% | 11 | 14 | 27.3% |
| Reading | | | | | | | | | |
| Apparent | 31 | 48 | 54.8% | 34 | 51 | 50.0% | 37 | 54 | 45.9% |
| Visc., cPs | | | | | | | | | |
| Plastic Visc., | 23 | 36 | 56.5% | 25 | 37 | 48.0% | 28 | 41 | 46.4% |
| cPs | | | | | | | | | |
| Yield Point, | 15 | 23 | 53.3% | 17 | 28 | 64.7% | 17 | 26 | 52.9% |
| Lbs/100 ft\hat{ }2 | | | | | | | | | |

### Example 6

### Prior Art Organoclay

BENTONE 155®, an organoclay, was added to the drilling fluid of Table 5 in amounts of 2.5 ppb and 5.0 ppb. The viscosity measurements at various shear rates and temperatures of the drilling fluid with the organoclay are included in Table 7. Table 7 shows that an oil-based drilling fluid incorporating 2.5 ppb organoclay (BENTONE 155®) alone as a rheological modifier exhibited a high shear rate (600 rpm) viscosity reading increase of 113.0% (54 to 115) when the temperature was reduced from 120° F. to 40° F., and a low shear rate (6 rpm) viscosity reading increase of 350.0% (4 to 18) when the temperature was reduced from 120° F. to 40° F.

An oil-based drilling fluid incorporating 5.0 ppb organoclay exhibited a high shear rate viscosity reading increase of 112.8% (78 to 166) when the temperature was reduced from 120° F. to 40° F. and a low shear rate viscosity reading increase of 240.0% (10 to 34) when the temperature was reduced from 120° F. to 40° F.

TABLE 7
BENTONE ® 155 Concentration Evaluation

| | Additive | | | | | |
|---|---|---|---|---|---|---|
| | BENTONE ® 155 | | | BENTONE ® 155 | | |
| | Additive(s) Concentration | | | | | |
| | 2.5 ppb | 2.5 ppb | 2.5 ppb | 5.0 ppb | 5.0 ppb | 5.0 ppb |
| OFI 800 | 120° F. | 40° F. | Percent | 120° F. | 40° F. | Percent |
| Viscosity | Test | Test | change | Test | Test | change |
| 600 RPM | 54 | 115 | 113.0% | 78 | 166 | 112.8% |
| Reading | | | | | | |
| 300 RPM | 31 | 73 | 135.5% | 50 | 112 | 124.0% |
| Reading | | | | | | |
| 200 RPM | 22 | 57 | 159.1% | 39 | 91 | 133.3% |
| Reading | | | | | | |
| 100 RPM | 15 | 40 | 166.7% | 27 | 66 | 144.4% |
| Reading | | | | | | |
| 6 RPM | 4 | 18 | 350.0% | 10 | 34 | 240.0% |
| Reading | | | | | | |
| 3 RPM | 3 | 16 | 433.3% | 9 | 32 | 255.6% |
| Reading | | | | | | |
| Apparent | 27 | 58 | 114.8% | 39 | 83 | 112.8% |
| Visc., cPs | | | | | | |
| Plastic Visc., | 23 | 42 | 82.6% | 28 | 54 | 92.9% |
| cPs | | | | | | |
| Yield Point, | 8 | 31 | 287.5% | 22 | 58 | 163.6% |
| Lbs/100 ft\hat{ }2 | | | | | | |

### Example 7

0.5 ppb of the drilling fluid additive of Example 1 was added to a drilling fluid with a formulation as per Table 5 in combination with 2.5 ppb BENTONE 155 and an ethoxylated amine which was mixed into Example 1. The viscosity measurements at various shear rates and temperatures of the drilling fluid with the organoclay and drilling fluid additive are included in Table 8. Table 8 shows that an oil-based drilling fluid incorporating 2.5 ppb organoclay (BENTONE 155®) and 0.5 ppb of the drilling fluid additive of this Example exhibited a high shear rate (600 rpm) viscosity reading increase of 59.3% (54 to 86) when the temperature was reduced from 120° F. to 40° F., and a low shear rate (6 rpm) viscosity reading increase of 116.7% (6 to 13) when the temperature was reduced from 120° F. to 40° F.

An oil-based drilling fluid incorporating 2.5 ppb organoclay and 1.25 ppb of the drilling fluid additive of Example 1 and an ethoxylated amine exhibited a high shear rate viscosity reading increase of 63.1% (65 to 106) when the temperature was reduced from 120° F. to 40° F. and a low shear rate viscosity reading increase of 25.0% (8 to 10) when the temperature was reduced from 120° F. to 40° F.

An oil-based drilling fluid incorporating 2.5 ppb organoclay and 2.5 ppb of the drilling fluid additive of Example 1 and an ethoxylated amine exhibited a high shear rate viscosity reading increase of 57.1% (77 to 121) when the temperature was reduced from 120° F. to 40° F. and a low shear rate viscosity reading decrease of 44.4% (9 to 5) when the temperature was reduced from 120° F. to 40° F.

TABLE 8
BENTONE ® 155 with Dimer Acid/DETA/EOamine Product Concentration Evaluation

| | Additive | | | | | | | | |
|---|---|---|---|---|---|---|---|---|---|
| | BENTONE ® 155 with Dimer | | | BENTONE ® 155 with Dimer | | | BENTONE ® 155 with Dimer | | |
| | Acid/DETA/EOamine | | | Acid/DETA/EOamine | | | Acid/DETA/EOamine | | |
| | Product | | | Product | | | Product | | |
| | Additive(s) Concentration | | | | | | | | |
| | 2.5 ppb/ | 2.5 ppb/ | 2.5 ppb/ | 2.5 ppb/ | 2.5 ppb/ | 2.5 ppb/ | 2.5 ppb/ | 2.5 ppb/ | 2.5 ppb/ |
| | 0.5 ppb | 0.5 ppb | 0.5 ppb | 1.25 ppb | 1.25 ppb | 1.25 ppb | 2.5 ppb | 2.5 ppb | 2.5 ppb |
| OFI 800 | 120° F. | 40° F. | Percent | 120° F. | 40° F. | Percent | 120° F. | 40° F. | Percent |
| Viscosity | Test | Test | change | Test | Test | change | Test | Test | change |
| 600 RPM | 54 | 86 | 59.3% | 65 | 106 | 63.1% | 77 | 121 | 57.1% |
| Reading | | | | | | | | | |
| 300 RPM | 33 | 54 | 63.6% | 39 | 63 | 61.5% | 47 | 66 | 40.4% |
| Reading | | | | | | | | | |
| 200 RPM | 24 | 42 | 75.0% | 28 | 45 | 60.7% | 35 | 47 | 34.3% |
| Reading | | | | | | | | | |
| 100 RPM | 16 | 27 | 68.8% | 19 | 28 | 47.4% | 22 | 26 | 18.2% |
| Reading | | | | | | | | | |
| 6 RPM | 6 | 13 | 116.7% | 8 | 10 | 25.0% | 9 | 5 | −44.4% |
| Reading | | | | | | | | | |
| 3 RPM | 6 | 12 | 100.0% | 7 | 9 | 28.6% | 8 | 4 | −50.0% |
| Reading | | | | | | | | | |
| Apparent | 27 | 43 | 59.3% | 33 | 53 | 60.6% | 39 | 61 | 56.4% |
| Visc., cPs | | | | | | | | | |
| Plastic Visc., | 21 | 32 | 52.4% | 26 | 43 | 65.4% | 30 | 55 | 83.3% |
| cPs | | | | | | | | | |
| Yield Point, | 12 | 22 | 83.3% | 13 | 20 | 53.8% | 17 | 11 | −35.3% |
| Lbs/100 ft\hat{ }2 | | | | | | | | | |

### Example 8

### Preparation of an Exemplary Inventive Mixture Using the Drilling Fluid Additive of Example 1

The additive of Example 1 was brought to 80° C. under agitation. Ethomeen® C/15 (821.8 grams) was added slowly while mixing at 500 RPM. The composition was mixed for 15 minutes. All of the Ethomeen® C/15 was incorporated into the mixture. The resulting product was poured into an appropriate storage container.

### Example 9

### Preparation of an Exemplary Inventive Composition

Empol® 1008 (635.2 grams) and Ethomeen® C/15 (692.1 gram) were placed in a 2 liter, 4-neck, preweighed reactor equipped with a Barrett distilling receiver and Friedrichs condenser. The contents were heated to 240° C. under a nitrogen blanket while mixing at 300 rpm. The reaction was allowed to continue until the acid value was ≦5.0 (mg KOH/grams). Once the acid value was ≦5.0, diethylenetriamine (112.6 grams) was charged to the reactor. The reaction continued for another two hours at 240° C. After this time, Armid® HT (164.0 grams) was added to the reactor and cooked for an additional 3 hours at 240° C. The resulting product was poured into storage containers.

### Example 10

### Prior Art Bentone® 155 Concentration Study

Table 9 represents a Bentone® 155 concentration study in a synthetic oil-based invert emulsion drilling fluid of Table 5. Table 9 shows that an oil-based drilling mud incorporating organoclay alone as a rheological modifier exhibits greater than 190% high shear rate viscosity reading increase at 4 ppb rheological agent when the temperature is reduced from 120° F. to 40° F. The drilling mud exhibits greater than a 160% low shear rate viscosity reading increase at 4 ppb rheological agent when the temperature is reduced from 120° F. to 40° F.

TABLE 9
BENTONE ® 155 CONCENTRATION EVALUATION
Rheological Additive BENTONE ® 155

| | Additive Concentration OFI 800 Viscosity | | | | | | | | |
|---|---|---|---|---|---|---|---|---|---|
| | 2 ppb | | | 4 ppb | | | 6 ppb | | |
| | Test Temperature | | | | | | | | |
| | 40° F. | 120° F. | 180° F. | 40° F. | 120° F. | 180° F. | 40° F. | 120° F. | 180° F. |
| 600 RPM Reading | 113 | 48 | 36 | 169 | 58 | 37 | 215 | 87 | 62 |
| 300 RPM Reading | 69 | 30 | 22 | 110 | 39 | 25 | 158 | 59 | 42 |
| 200 RPM Reading | 53 | 23 | 18 | 88 | 32 | 19 | 133 | 50 | 35 |
| 100 RPM Reading | 36 | 16 | 12 | 65 | 24 | 14 | 99 | 38 | 26 |
| 6 RPM Reading | 13 | 6 | 3 | 26 | 10 | 6 | 48 | 20 | 14 |
| 3 RPM Reading | 13 | 5 | 2 | 25 | 9 | 6 | 45 | 18 | 13 |
| Apparent Visc., cPs | 57 | 24 | 18 | 85 | 29 | 19 | 108 | 44 | 31 |
| Plastic Visc. cPs | 44 | 18 | 14 | 59 | 19 | 12 | 57 | 38 | 20 |
| Yield Point, | 25 | 12 | 8 | 51 | 20 | 13 | 101 | 31 | 22 |
| Lbs./100 Ft² | | | | | | | | | |

### Example 11

### Drilling Fluid Containing the Inventive Drilling Fluid Additive of Example 8 in Combination with an Organoclay

Table 10 presents the effect of the product of Example 8 on the viscosity of an oil-based drilling mud of Table 5. When 0.5 ppb of the additive is combined with 2 ppb of BENTONE® 155, the 600 rpm Fann reading only increases by 75% (48 to 84) when the temperature is reduced from 120° F. to 40° F. Two ppb of the BENTONE® 155 alone gave rise to a 135% increase (Table 2) under comparable conditions. The low shear rate viscosity reading at 6 rpm, showed a 33.3% viscosity increase as the temperature was reduces whereas the BENTONE® 155 alone provided a 115% increase.

TABLE 10
Impact of Example 8 on Viscosity: Temperature Profile
Additive Concentration
BENTONE 155 (2.0 ppb)/Example 8 (1.0 ppb)

| | Test Temperature | | |
|---|---|---|---|
| OFI 800 Viscosity | 40° F. | 120° F. | 180° F. |
| 600 RPM Viscosity | 84 | 48 | 35 |
| 300 RPM Viscosity | 50 | 31 | 24 |
| 200 RPM Viscosity | 40 | 25 | 20 |
| 100 RPM Viscosity | 27 | 19 | 15 |
| 6 RPM Viscosity | 12 | 9 | 6 |
| 3 RPM Viscosity | 11 | 8 | 5 |
| Apparent Visc., cPs | 42 | 24 | 18 |
| Plastic Visc., cPs | 34 | 17 | 11 |
| Yield Point, | 16 | 14 | 13 |
| Lbs./100 Ft² | | | |

### Example 12

### Drilling Fluid Containing the Inventive Drilling Fluid Additive of Example 9 in Combination with an Organoclay

Table 11 below presents the effects of the product of Example 9 on the viscosity of an oil-based drilling mud of Table 5. When 1 ppb of the additive is used along with 3 ppb of BENTONE® 155, the 600 rpm Fann reading only increases by 56.9% (65 to 102) when the temperature is reduced from 120° F. to 40° F. Four ppb of the BENTONE® 155 alone gave rise to a 190% increase. The low shear rate viscosity, measured at 6 rpm, showed a 29.4% viscosity decrease as the temperature was reduced.

TABLE 11
Impact of Example 9 on Viscosity: Temperature Profile
Additive Concentration
BENTONE 155 (3.0 ppb)/Example 9 (1.0 ppb)

| | Test Temperature | | |
|---|---|---|---|
| OFI 800 Viscosity | 40° F. | 120° F. | 180° F. |
| 600 RPM Viscosity | 102 | 65 | 50 |
| 300 RPM Viscosity | 63 | 44 | 36 |
| 200 RPM Viscosity | 48 | 36 | 30 |
| 100 RPM Viscosity | 31 | 28 | 24 |
| 6 RPM Viscosity | 12 | 17 | 15 |
| 3 RPM Viscosity | 11 | 16 | 14 |
| Apparent Visc., cPs | 51 | 33 | 25 |
| Plastic Visc., cPs | 39 | 21 | 14 |
| Yield Point, | 24 | 23 | 22 |
| Lbs./100 Ft² | | | |

What is claimed:

1. A drilling fluid additive having a drilling fluid viscosity regulating property which imparts a stable rheological profile to an oil based drilling fluid, wherein the stable rheological profile is characterized by a substantially constant high shear rate viscosity reading over a temperature range of about 120° F. to about 40° F., said high shear rate viscosity reading being measured at 600 rpm.

2. The drilling fluid additive of claim 1, wherein the substantially constant high shear rate viscosity corresponds to an increase in high shear rate viscosity reading for the oil based drilling fluid of up to 70% over a temperature range of about 120° F. to about 40° F.

3. The drilling fluid additive of claim 2, wherein the stable rheological profile is further characterized by the oil based drilling fluid having a low shear rate viscosity reading of at least 6 viscosity units over a temperature range of about 120° F. to about 40° F., said low shear rate viscosity reading being measured at 6 rpm.

4. The drilling fluid additive of claim 3, wherein the stable rheological profile is further characterized by a substantially constant equivalent circulating density over a temperature range of about 120° F. to about 40° F.

5. The drilling fluid additive of claim 1, wherein the drilling fluid additive is substantially free of organophilic clay.

6. The drilling fluid additive of claim 1, wherein the drilling fluid additive contains an organophilic clay.

7. A drilling fluid additive having a drilling fluid viscosity regulating property which imparts a stable rheological profile to an oil based drilling fluid, wherein the stable rheological profile is characterized by a substantially constant equivalent circulating density over a temperature range of about 120° F. to about 40° F.

8. the drilling fluid additive of claim 7, wherein the stable rheological profile is further characterized by an increase in a high shear rate viscosity reading for the oil based drilling fluid of up to 70% over a temperature range of about 120° F. to about 40° F., said high shear rate viscosity reading being measured at 600 rpm.

9. The drilling fluid additive of claim 8, wherein the stable rheological profile is further characterized by the oil based drilling fluid having a low shear rate viscosity reading of at least 6 viscosity units over a temperature range of about 120° F. to about 40° F., said low shear rate viscosity reading being measured at 6 rpm.

10. The drilling fluid additive of claim 7, wherein the drilling fluid additive is substantially free of organophilic clay.

11. The drilling fluid additive of claim 7, wherein the drilling fluid additive contains an organophilic clay.

12. A oil based drilling fluid comprising:
a continuous oil phase;
a weighting agent;
a filtrate reducer;
an emulsifier; and
an effective amount of a rheological additive,
wherein the oil based drilling fluid exhibits a substantially constant high shear rate viscosity reading over a temperature range of about 120° F. to about 40° F., said high shear rate viscosity reading being measured at 600 rpm.

13. The oil based drilling fluid of claim 12, wherein the substantially constant high shear rate viscosity corresponds to an increase in high shear rate viscosity of up to 70% when operating at a temperature range of about 120° F. to about 40° F.

14. The oil based drilling fluid of claim 13, wherein the oil based drilling fluid further exhibits a low shear rate viscosity reading of at least 6 viscosity units over a temperature range of about 120° F. to about 40° F., said low shear rate viscosity reading being measured at 6 rpm.

15. The oil based drilling fluid of claim 12, wherein the oil based drilling fluid further exhibits a substantially constant equivalent circulating density over a temperature range of about 120° F. to about 40° F.

16. The oil based drilling fluid of claim 12 further comprising an oil based invert emulsion drilling fluid.

17. The oil based drilling fluid of claim 12 further comprising an organophilic clay.

18. The oil based drilling fluid of claim 12 being substantially free of organophilic clay.

19. A oil based drilling fluid comprising:
a continuous base oil phase;
a weighting agent;
a filtrate reducer;
an emulsifier; and
an effective amount of a rheological additive,
said rheological additive having a drilling fluid viscosity regulating property which imparts a stable rheological profile to the oil based drilling fluid, wherein the stable rheological profile is characterized by a substantially constant equivalent circulating density over a temperature range of about 120° F. to about 40° F.

20. The oil based drilling fluid of claim 19, wherein the stable rheological profile is further characterized by an increase in a high shear rate viscosity reading for the oil based drilling fluid of up to 70% over a temperature range of about 120° F. to about 40° F., said high shear rate viscosity reading being measured at 600 rpm.

21. The oil based drilling fluid of claim 20, wherein the stable rheological profile is further characterized by a low shear rate viscosity (LSR) reading of at least 6 viscosity units over a temperature range of about 120° F. to about 40° F., said low shear rate viscosity reading being measured at 6 rpm.

22. The oil based drilling fluid of claim 19 further comprising an organophilic clay.

23. The oil based drilling fluid of claim 19 being substantially free of organophilic clay.

24. A method of drilling in a subterranean formation comprising the steps of:
providing an oil based drilling fluid
drilling into the subterranean formation with the oil based drilling fluid; said oil based drilling fluid comprising:
a continuous base oil phase;
a weighting agent;
a filtrate reducer;
an emulsifier; and
an effective amount of a rheological additive,
wherein the oil based drilling fluid exhibits a substantially constant high shear rate viscosity reading over a temperature range of about 120° F. to about 40° F., said high shear rate viscosity reading being measured at 600 rpm.

25. The method of claim 24, wherein the oil based drilling fluid further exhibits a change in high shear rate viscosity reading of up to 70% when operating at a temperature range of about 120° F. to about 40° F.

26. The method of claim 25, wherein the oil based drilling fluid further exhibits a low shear rate viscosity reading of at least 6 viscosity units over a temperature range of about 120° F. to about 40° F., said low shear rate viscosity reading being measured at 6 rpm.

27. The method of claim 24, wherein the oil based drilling fluid comprising an organophilic clay.

28. The method of claim 24, wherein the oil based drilling fluid is substantially free of organophilic clay.

29. A method of drilling in a subterranean formation comprising the steps of:
providing an oil based drilling fluid
drilling into the subterranean formation with the oil based drilling fluid; said oil based drilling fluid comprising:
a continuous base oil phase;
a weighting agent;
an emulsifier; and
an effective amount of a rheological additive,
said rheological additive having a drilling fluid viscosity regulating property which imparts a stable rheological profile to an oil based drilling fluid, wherein the stable rheological profile is characterized by a substantially constant equivalent circulating density over a temperature range of about 120° F. to about 40° F.

30. The method of claim 29, wherein the stable rheological profile is further characterized by a change in high shear rate viscosity reading for the oil based drilling fluid of up to 70% over a temperature range of about 120° F. to about 40° F., said high shear rate viscosity reading being measured at 600 rpm.

31. The method of claim 30, wherein the stable rheological profile is further characterized by a low shear rate viscosity reading of at least 6 over a temperature range of about 120° F. to about 40° F., said low shear rate viscosity reading being measured at 6 rpm

32. The method of claim 29, wherein the oil based drilling fluid comprising an organophilic clay.

33. The method of claim 29, wherein the oil based drilling fluid is substantially free of organophilic clay.
